(19) United States
(12) Patent Application Publication
(10) Pub. No.: US 2001/0006303 A1
(43) Pub. Date: Jul. 5, 2001

(54) Universal wheelchair/seat restraint assembly

(76) Inventor: Jean Marc Girardin, Cambridge (CA)

Correspondence Address: Richard J. Hicks, P.O. Box 595, Kingston, ON, K7L 4X1, CA

(21) Appl. No.: 09/780,969

(22) Filed: Feb. 12, 2001

Related U.S. Application Data
(63) Continuation-in-part of application No. 09/387,841, filed on Sep. 1, 1999.

(51) Int. Cl. B60R 22/00

(52) U.S. Cl. 297/475; 297/483

(57) ABSTRACT

A universal passenger restraint system which can be used by either a passenger sitting on a vehicle seat or a passenger in a wheelchair is described. A reel is mounted against the vehicle wall and a first belt extends therefrom having a female pin connector at the distal end and a male buckle slidably mounted intermediate the ends. A second belt is mounted on the opposite side of the passenger from the first belt and is provided with a male pin assembly, at the distal end thereof, to be received by the female pin connector. When used by a wheelchair passenger, a third belt is provided for attachment to the vehicle and having, at the distal end thereof a female buckle to releasably engage with the male buckle on the first belt.

### CROSS REFERENCE TO RELATED APPLICATION

This application is a continuation-in-part to my earlier filed U.S. patent application Ser. No. 09/387,841 filed Sep. 1, 1999.

### FIELD OF INVENTION

This invention relates to a passenger restraint system for use in a vehicle which can be used to restrain a passenger seated either in a wheelchair or on a regular vehicle seat.

### BACKGROUND OF INVENTION

Restraint systems to hold a passenger in a vehicle seat are, of course, well known and generally incorporate a shoulder belt and an integral lap belt with a retractor therefor, anchored to the floor or wall of the vehicle. The lap belt is usually provided with a tongue piece which is slidably inserted into a buckle assembly which is also anchored to the floor. Restraint systems to hold a passenger, seated in a wheelchair, in a safe and secure manner in a bus or the like are also known, and attention is directed to the well known Q'Straint (Reg. T.M) system which is marketed by Giram LLC of Fort Lauderdale, Fla. Heretofore, however, there has not been a universal system which could be used by either a wheelchair passenger or a seat passenger.

### OBJECT OF INVENTION

It is, therefore, an object of the present invention to provide a universal restraint system for use by a regular vehicle passenger or by a wheelchair passenger, using a single retractor assembly.

### BRIEF DESCRIPTION OF INVENTION

By one aspect of this invention there is a passenger seated in a wheelchair provided a passenger restraint system for use in a passenger carrying vehicle comprising:

(a) a reel for attachment to a selected mounting in said vehicle;

(b) a first elongated belt having proximal and distal ends retractably mounted on said reel at said proximal end thereof, and a female pin connector mounted at said distal end;

(c) a male buckle provided with a pair of parallel slots through which said first belt is threaded so as to slidably and lockably adjustably mount said buckle on said belt intermediate said proximal and distal ends; and

(d) a second elongated belt having a first end provided with means for attachment to said vehicle, and a second end provided with a male pin assembly adapted to be received by said female pin connector.

### BRIEF DESCRIPTION OF DRAWINGS

FIG. 1 shows a sketch of a retractor assembly according to one embodiment of the present invention;

FIG. 2 shows a sketch of the pin connector assembly;

FIG. 3 shows a sketch of the buckle assembly;

FIG. 4 is a front view of the system as applied to a passenger on a vehicle seat.

FIG. 5 is a front view of the system as applied to a passenger seated in a wheelchair.

### DETAILED DESCRIPTION OF PREFERRED EMBODIMENTS

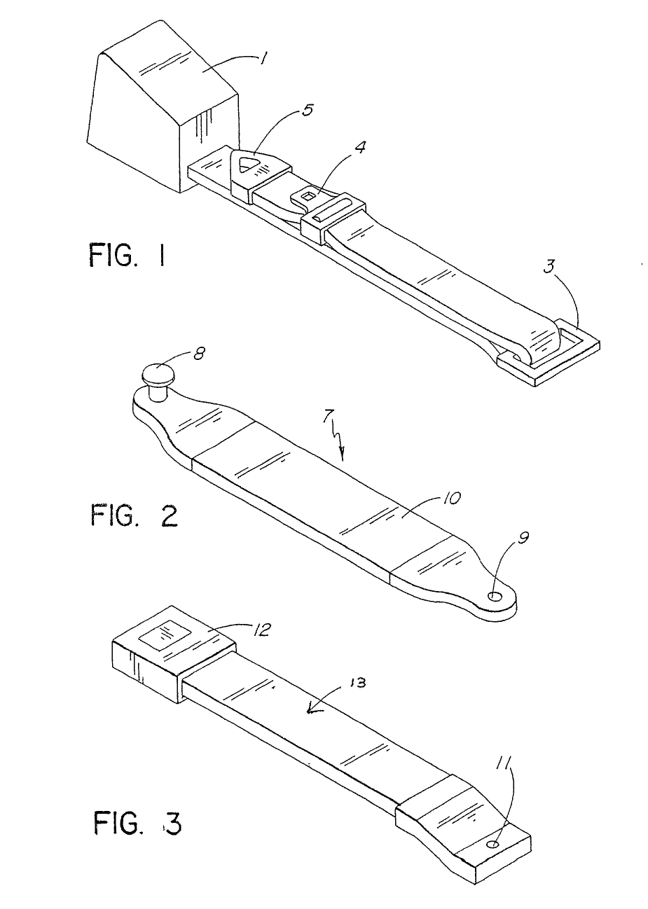

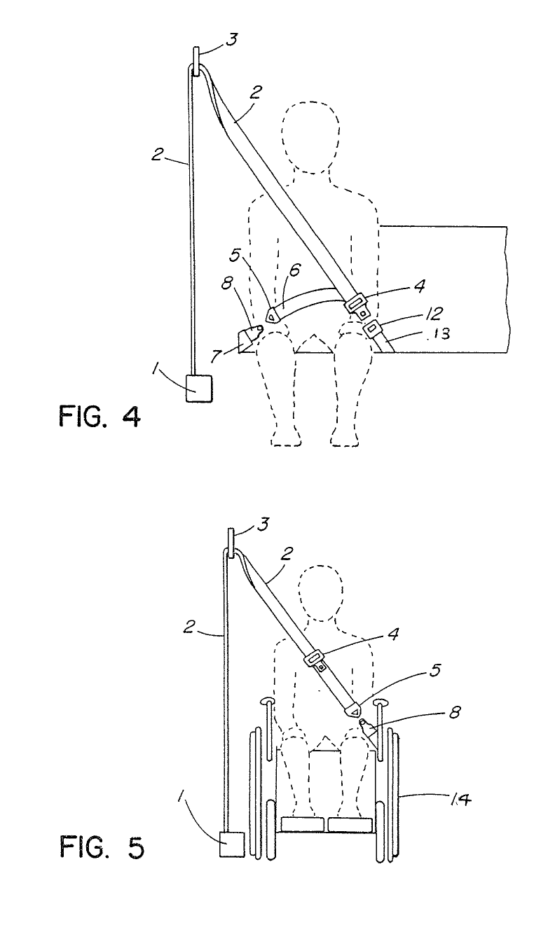

In FIGS. 1, 4 and 5 there is shown a wall or floor mounted retractor assembly comprising a spring loaded reel 1, a nylon webbing, or the like, belt 2 mounted on reel 1 at its proximal end, turning slide 3, intermediate male buckle or tongue 4, which is provided with double slots through which belt 2 passes so as to provide for slideable and lockable adjustment thereof on belt 2, and female pin connector 5 at the distal end 6 of belt 2. In the embodiment shown in FIG. 4, namely a passenger sitting on a vehicle seat, a pin connector assembly 7 (FIG. 2) having a short belt 10 with a male pin end 8 and a floor or seat attachment at end 9 is mounted either to one side of the vehicle seat or to the floor adjacent the seat so that the male pin end 8 may be releasably connected to female pin connector 5. A buckle assembly 13 (FIG. 3) is similarly fastened to either the vehicle seat or to the floor of the vehicle adjacent the seat on the opposite side of the seat to assembly 7. Buckle assembly 13 is provided with a floor or seat attachment means at end 11 and a female releasable buckle means at end 12, adapted to slidably and releasably engage the tongue 4.

In the embodiment shown in FIG. 5, wherein the passenger is seated in a wheelchair and not upon the vehicle seat, the buckle assembly 10 and tongue 4 are not used. Tongue 4 is retained securely, but adjustably, out of the way by means of the double slots in tongue 4 through which belt 2 passes as described hereinabove. In this case, the assembly 7 is mounted on the floor (or wheelchair 13) on the side opposite the reel assembly 1 and turning slide 3 with the male pin end 8 uppermost. The belt is drawn diagonally downwardly across the passenger's chest, as seen in FIG. 5, so that female pin connector 5 may be releasably secured to the male pin end 8 of assembly 7.

It will be appreciated that wheelchair 14 may be secured in the vehicle with conventional hooks and webbing straps (not shown) at each corner thereof. It will also be appreciated that the tongue 4 is not compatible with the male pin 8 and cannot be inadvertently mated therewith.

I claim:

1. A passenger restraint system for use in a passenger carrying vehicle comprising:
(a) a reel for attachment to a selected mounting in said vehicle;
(b) a first elongated belt having proximal and distal ends retractably mounted on said reel at said proximal end thereof and having a female pin connector at said distal end;
(c) a male buckle provided with a pair of parallel slots through which said belt is threaded so as to slidably and lockably adjustably mount said male buckle on said first belt intermediate said proximal and distal ends; and
(d) a second elongated belt having a first end provided with means for attachment to said vehicle, and a second end provided with a male pin assembly adapted to be received by said female pin connector.

2. A passenger restraint system as claimed in claim 1 including:
(d) a third elongated belt having a first end provided with means for attachment to said vehicle, and a second end provided with a female buckle adapted to slidably and releasably engage said male buckle on said first elongated belt.
